(19) United States
(12) Patent Application Publication
(10) Pub. No.: US 2011/0044712 A1
(43) Pub. Date: Feb. 24, 2011

(54) IMAGE FORMING APPARATUS

(75) Inventor: Norio Tanaka, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/857,200

(22) Filed: Aug. 16, 2010

Related U.S. Application Data
(60) Provisional application No. 61/236,231, filed on Aug. 24, 2009.

(51) Int. Cl. G03G 15/00

(52) U.S. Cl. 399/72; 399/81

(57) ABSTRACT

Certain embodiments provide an image forming apparatus including: an image processing unit; a printer; a memory configured to store an adjustment value; an operation panel configured to receive a change for the adjustment value according to a user input; an adjuster configured to change, according to input information from the operation panel, the adjustment value from a first value to a second value; and a print controller configured to adjust a position of an image according to the second value and cause the printer to print a numerical value character string representing the second value together with a test pattern.

### CROSS-REFERENCE TO RELATED APPLICATION

The present application claims priority under 35 U.S.C. 119 to U.S. Provisional Application Ser. No. 61/236,231, entitled IMAGE FORMING APPARATUS, to TANAKA, filed on Aug. 24, 2009, the entire disclosure of which is incorporated herein by reference.

### FIELD

Embodiments described herein relate generally to an image forming apparatus and an image position adjusting method.

### BACKGROUND

An image forming apparatus has a function of setting margin amounts of the four sides of a sheet. The margin amounts indicate distances on the sheet between sheet ends and ends of an image area.

An external storage device in the image forming apparatus stores initial values of the margin amounts of the four sides. The external storage device stores a reading magnification of a scanner, a writing magnification of a laser exposure unit, and the like.

A serviceperson adjusts, with respect to a sheet, a position where an image is formed. The margin amounts, the reading magnification, the writing magnification, and the like are adjustment values. The position of the image with respect to the sheet is changed according to the adjustment values.

The serviceperson sets the adjustment values in the image forming apparatus. After the setting, the serviceperson causes the image forming apparatus to print-output a test pattern.

The serviceperson needs to reset the adjustment values while looking at a result of the printing of the test pattern. The serviceperson performs manual calculation or the like to calculate, from the adjustment values currently set in the image forming apparatus, adjustment values that should be set anew.

The serviceperson needs to cause the image forming apparatus to print the test pattern again. The serviceperson needs to visually check a print-output.

If the serviceperson cannot obtain an expected image position as a result of the check, the serviceperson has to set adjustment values and cause the image forming apparatus to print the test pattern again.

Target adjustment values are different among plural image forming apparatuses. The adjustment values fluctuate according to individual differences of machine bodies.

If the adjustment cannot be completed even if the adjustment values are changed once or twice, the serviceperson has to repeat the printing on a sheet and the setting of adjustment values many times.

Types of the adjustment values are several hundred items. The serviceperson needs to adjust the plural adjustment values one by one. Long time is required for the adjustment.

As an example, content of the adjustment is to shift an image toward the front edge of a sheet by several millimeters or shift the image toward the rear edge of the sheet by several millimeters.

The serviceperson inputs a several-digit code to an operation panel. A mode of the image forming apparatus transitions to an adjustment mode.

The operation panel displays a value in a range of 0 to 255 with 128 set as a center value. A manual simply indicates a distance the image is shifted when a display value is changed by one. A value of the distance is smaller than 1 millimeter. The value is a fraction. A person cannot intuitively treat the value.

The display value needs to be increased or reduced. The serviceperson manually calculates a unit for changing a numerical value on the operation panel. The serviceperson takes time and labor to calculate the numerical value input to the operation panel.

### BRIEF DESCRIPTION OF THE DRAWINGS

FIG. 1 is a front view of an image forming apparatus;

FIG. 2 is an enlarged diagram of a printer;

FIG. 3 is a block diagram of a control system of the image forming apparatus;

FIG. 4A is a diagram of a sheet itself on which a test pattern is printed;

FIG. 4B is a diagram for explaining the test pattern on the sheet shown in FIG. 4A;

FIG. 5 is a flowchart for explaining an example of a processing procedure of automatic printing in adjusting one adjustment value;

FIGS. 6A to 6C are diagrams of an example of print-output of one kind of adjustment values;

FIGS. 7A to 7C are diagrams of an example of print-output of adjustment values having a step width twice as large as a predetermined step width;

FIG. 8 is a flowchart for explaining an example of a processing procedure of automatic printing in adjusting plural adjustment values;

FIGS. 9A to 9C are diagrams of examples of print-output of the plural adjustment values; and

FIGS. 10A and 10B are diagrams of examples of print-output of the plural adjustment values, step widths of which are changed.

### DETAILED DESCRIPTION

Certain embodiments provide an image forming apparatus including: an image processing unit configured to generate image data and test pattern data; a printer configured to print an image or a test pattern on a sheet surface of a sheet according to print data output by the image processing unit; a memory configured to store an adjustment value for changing a position where the printer forms an image on the sheet surface; an operation panel configured to receive a change for the adjustment value according to a user input; an adjuster configured to change, according to input information from the operation panel, the adjustment value stored by the memory from a first value to a second value; and a print controller configured to adjust the position according to the second value set by the adjuster and cause the printer to print a numerical value character string representing the second value together with the test pattern.

An image forming apparatus and an image position adjusting method are explained in detail below with reference to the accompanying drawings as examples. In the figures, the same components are denoted by the same reference numerals and signs and redundant explanation of the components is omitted.

### EMBODIMENT

An image forming apparatus according to an embodiment is a MFP (multi function peripheral).

An image position adjusting method according to the embodiment is a method for the MFP to automatically change adjustment values and print the adjustment values after the change together with a test pattern.

The adjustment values indicate parameters for changing a position where a printer unit (a printer) forms an image on a sheet surface.

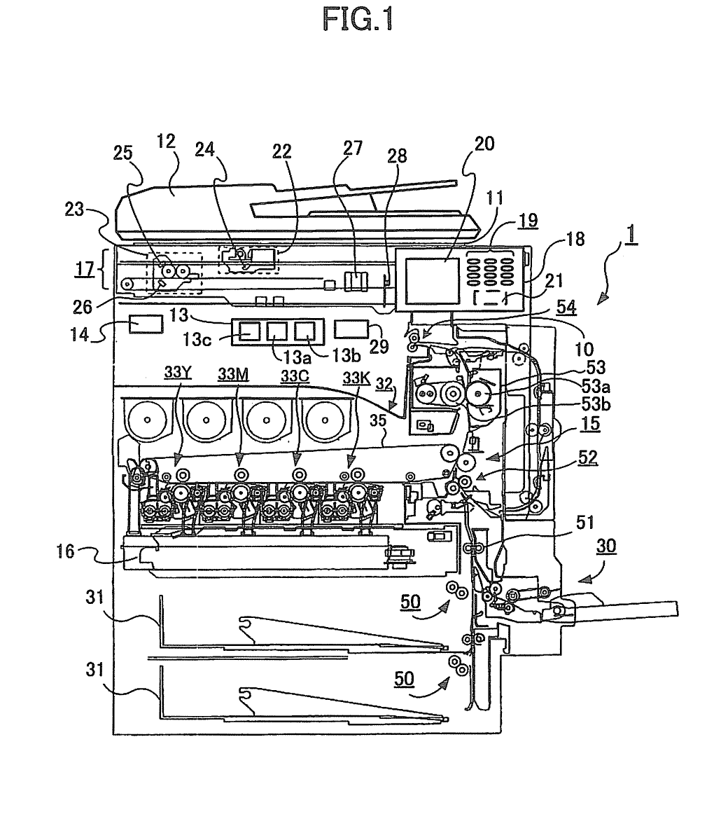

FIG. 1 is a front view of the MFP. In FIG. 1, a front view of a MFP 1 viewed in a direction from the front side to the rear side is shown.

The MFP 1 includes a glass plate 11 in an upper part of a main body 10. The MFP 1 includes an automatic document feeder 12 on the glass plate 11.

The MFP 1 includes an external storage device 14 (a memory) that a main controller 13 and the like access. The main controller 13 controls the entire MFP 1.

The external storage device 14 uses a hard disk drive. The external storage device 14 stores the adjustment values.

The external storage device 14 stores, as the adjustment values, margin amounts, a writing magnification, a reading magnification, conveying speed, and the like.

The external storage device 14 stores a leading end margin amount, a trailing end margin amount, a front side end margin amount, and a rear side end margin amount.

The leading end and the trailing end respectively indicate a leading end and a trailing end of a sheet with respect to a sheet conveying direction. The front side end and the rear side end respectively indicate a front side and a rear side of the main body 10. The front side end and the rear side end are orthogonal to the sheet conveying direction, respectively.

The writing magnification indicates a magnification at which a laser exposure unit 16 writes image data on the sheet. The reading magnification indicates a magnification at which a scanner 17 reads an original image from an original document. The conveying speed indicates rotating speed of a motor for a sheet conveying unit 30.

The MFP 1 includes an operation panel 18 in an upper part of the main body 10. The operation panel 18 generates the adjustment values according to user operation.

The operation panel 18 includes plural keys 19, a display 20, and a driver circuit 21. The keys 19 are operation buttons. The display 20 is a display screen for interaction. The driver circuit 21 is a control board.

The driver circuit 21 includes a CPU (central processing unit), a ROM (read only memory), and a RAM (random access memory).

The keys 19 notify the main controller 13 of a command or a numerical value input by a user. The display 20 displays current setting information of the MFP 1. The display 20 echoes back information input to the keys 19.

The MFP 1 includes the scanner 17 under the glass plate 11 in the main body 10. The scanner 17 reads an original document fed by the automatic document feeder 12 or an original document placed on the glass plate 11 and generates image data.

The MFP 1 includes a first carriage 22 and a second carriage 23 below the glass plate 11. The carriages 22 and 23 move in parallel to a plate surface of the glass plate 11 in opposite directions from each other.

The carriage 22 includes a mirror 24. The carriage includes mirrors 25 and 26. The mirror 24 leads reflected light, which is reflected from the original document, to the mirror 25. The mirror 25 leads the reflected light, which is reflected from the mirror 24, to the mirror 26.

The mirror 26 leads the reflected light, which is reflected from the mirror 25, to a lens 27. The lens 27 focuses the reflected light, which is reflected from the mirror 26, on a surface of a CCD (Charge Coupled Device) sensor 28.

The CCD sensor 28 is a four-line CCD. The CCD sensor 28 photoelectrically converts each of light beams focused for each of three colors. The CCD sensor 28 accumulates charges for a predetermined time for each of the colors and, then, outputs charge amount information for each of the colors.

The MFP 1 includes an image processing unit 29 connected to an output side of the CCD sensor 28. The image processing unit 29 generates image data and test pattern data. The image processing unit 29 is an LSI (large scale integration) configured to convert image data of three colors received from the scanner 17 into four print colors.

The MFP 1 includes the main controller 13 connected to the printer unit 15 (printer), the external storage device 14, the operation panel 18, and the like. The main controller 13 functions as an adjuster and a print controller.

The main controller 13 changes, according to input information received from the operation panel 18, the adjustment values stored by the external storage device 14 from initial values to values input by the user. The main controller 13 changes the adjustment values from current values to other values obtained by shifting the current values.

The main controller 13 adjusts, according to the input values, a position of an image with respect to a sheet. The main controller 13 attaches numerical value character strings representing the input values to a test pattern and causes the printer unit 15 to print the test pattern together with the numerical value character strings.

The main controller 13 uses a CPU 13c, a ROM 13a, and a RAM 13b. The ROM 13a stores a control program. The RAM 13b is a system memory.

The MFP 1 includes the printer unit 15 in the center in the height direction in the main body 10.

The printer unit 15 prints an image or a test pattern on a sheet according to print data output by the image processing unit 29.

The printer unit 15 prints the image on a sheet surface of the sheet. The printer unit 15 prints the test pattern in an area same as an area where the image is printed.

The printer unit 15 executes a printing process. The printer unit 15 modulates laser beams of four colors according to four print color data, respectively. The printer unit 15 forms toner images on the sheet.

The MFP 1 includes the sheet conveying unit 30 in a lower part of the main body 10. The sheet conveying unit 30 includes plural cassettes 31. The cassettes 31 are paper feeding cassettes configured to store sheets. Sheet sizes of the cassettes 31 are different from one another.

The sheet conveying unit 30 supplies a sheet to the printer unit 15. The printer unit 15 processes image data read by the scanner 17 and forms an image obtained by the processing on the sheet.

The MFP 1 includes a fixing device 53 in an upper part of the main body 10. The fixing device 53 fixes a toner image on the sheet. A roller pair 54 discharges the sheet, which is received from the fixing device 53, onto a paper discharge unit 32.

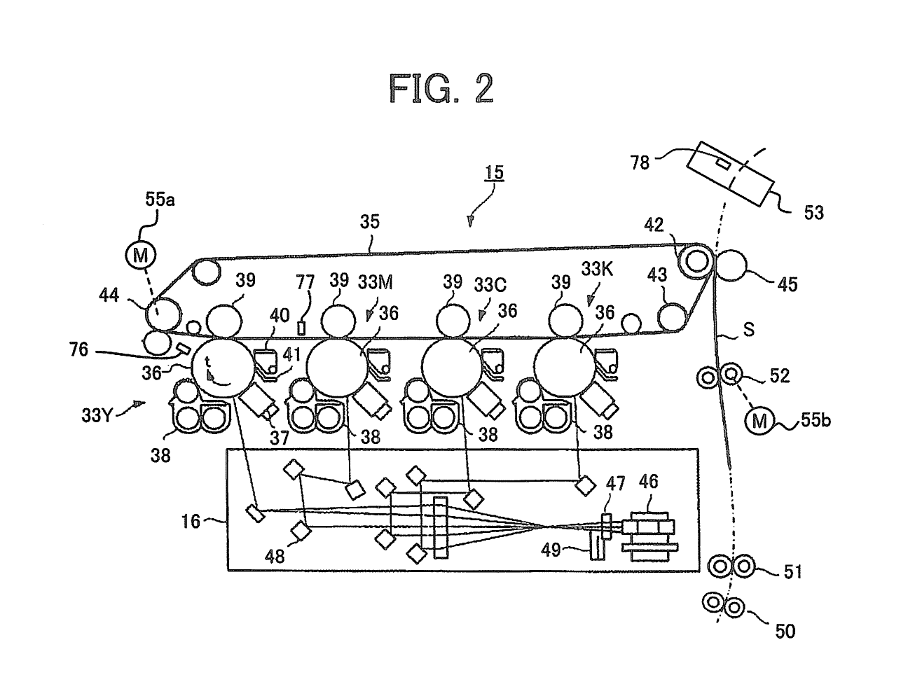

FIG. 2 is an enlarged diagram of the printer unit 15. The reference numerals and signs described above denote the same components.

The printer unit 15 includes an image forming unit 33Y for yellow (Y), an image forming unit 33M for magenta (M), an image forming unit 33C for cyan (C), and an image forming unit 33K for black (K). The printer unit 15 includes the laser exposure unit 16 and a belt 35.

The image forming unit 33Y includes a photoconductive drum 36, a charging device 37, a developing device 38, and a primary transfer roller 39.

The photoconductive drum 36 holds a latent image on a photoconductive member.

The charging device 37 uniformly charges the photoconductive member on the photoconductive drum 36. The laser exposure unit 16 forms a latent image on the photoconductive drum 36.

The developing device 38 develops the latent image on the photoconductive drum 36. The developing device 38 includes a magnet roller and a mixer.

The primary transfer roller 39 is rotated by a motor. The primary transfer roller 39 is charged. The primary transfer roller 39 transfers a toner image on the photoconductive drum 36 onto the belt 35.

The belt 35 is an intermediate transfer belt. The belt 35 is an endless belt. The belt 35 travels counterclockwise in the figure.

The photoconductive drum 36 rotates in a “t” direction. The photoconductive drum 36 has a position to be exposed. The laser exposure unit 16 irradiates a laser beam having a yellow wavelength on the position to be exposed. The photoconductive drum 36 forms an electrostatic latent image on the photoconductive drum 36.

The image forming unit 33Y includes a cleaner 40. The cleaner 40 removes a toner remaining on the surface of the photoconductive drum 36 using a blade 41.

The image forming units 33M, 33C, and 33K have configurations substantially the same as the configuration of the image forming unit 33Y.

The belt 35 is wound around rollers 42, 43, and 44. The roller 42 is a driving roller. Both the rollers 43 and 44 are driven rollers.

Primary transfer voltage is applied to the primary transfer rollers 39. In positions of the belt 35 opposed to the photoconductive drums 36, the photoconductive drums 36 transfer toner images onto the belt 35.

The printer unit 15 includes a secondary transfer roller 45. The secondary transfer roller 45 is opposed to the roller 42.

A sheet passes between the roller 42 and the secondary transfer roller 45. The roller 42 and the secondary transfer roller 45 nip the sheet together with the belt 35. The secondary transfer roller 45 applies secondary transfer voltage to the sheet. The secondary transfer roller 45 transfers the toner images on the belt 35 onto the sheet.

The laser exposure unit 16 includes a polygon mirror 46, plural lenses 47, plural mirrors 48, and laser diodes 49.

The polygon mirror 46 and the mirrors 48 scan laser beams emitted from the laser diodes 49 in axis directions of the photoconductive drums 36. The lenses 47 parallelize the laser beams output by the laser diodes 49.

The printer unit 15 scans the photoconductive members in a main scanning direction with the laser beams from the laser exposure unit 16.

The MEP 1 includes roller pairs 50, 51, and 52 between the cassettes 31 shown in FIG. 1 and the secondary transfer roller 45.

The roller pairs 50 separate a sheet from the insides of the cassettes 31. The roller pair 51 leads the sheet to the printer unit 15. The roller pair 52 corrects a skew of the sheet.

The MFP 1 includes a fixing device 53 downstream of the secondary transfer roller 45 in a direction in which the sheet is conveyed. The fixing device 53 includes a heat roller 53a and a press roller 53b. The fixing device 53 discharges the sheet onto the paper discharge unit 32.

Nips of the roller pairs 50, 51, and 52, a guide member, the secondary transfer roller 45, and the fixing device 53 define a conveying path for the sheet.

A motor 55a, a motor 55b, the secondary transfer roller 45, the roller 42, the heat roller 53a, the press roller 53b, the roller pair 54, and the guide member configure the sheet conveying unit 30.

The motor 55a is a belt motor. The motor 55b is a feed motor and rotates the roller pairs 50, 51, and 52.

The main controller 13 detects that an original document is inserted into the scanner 17. The main controller 13 generates a print job. The main controller 13 causes the printer unit 15 to operate.

The sheet conveying unit 30 picks up a sheet from any one of the cassettes 31. The sheet conveying unit 30 supplies the sheet into the conveying path. The sheet conveying unit 30 conveys the sheet in the conveying path upward.

The printer unit 15 forms electrostatic latent images on the four photoconductive drums 36 on the basis of image data generated by the scanner 17. The developing devices 38 agitate toners of the respective colors. The developing devices 38 supply the toners to the photoconductive drums 36. The electrostatic latent images are visualized.

Chargers charge the primary transfer rollers 39.

The toner images of the four colors move onto the belt surface of the belt 35. The secondary transfer roller 45 transfers a color toner image obtained onto the sheet.

The fixing device 53 heats and presses the sheet. The fixing device 53 fixes the toner images of the four colors on the sheet. The sheet conveying unit 30 outputs the sheet, which is received from the fixing device 53, to the paper discharge unit 32.

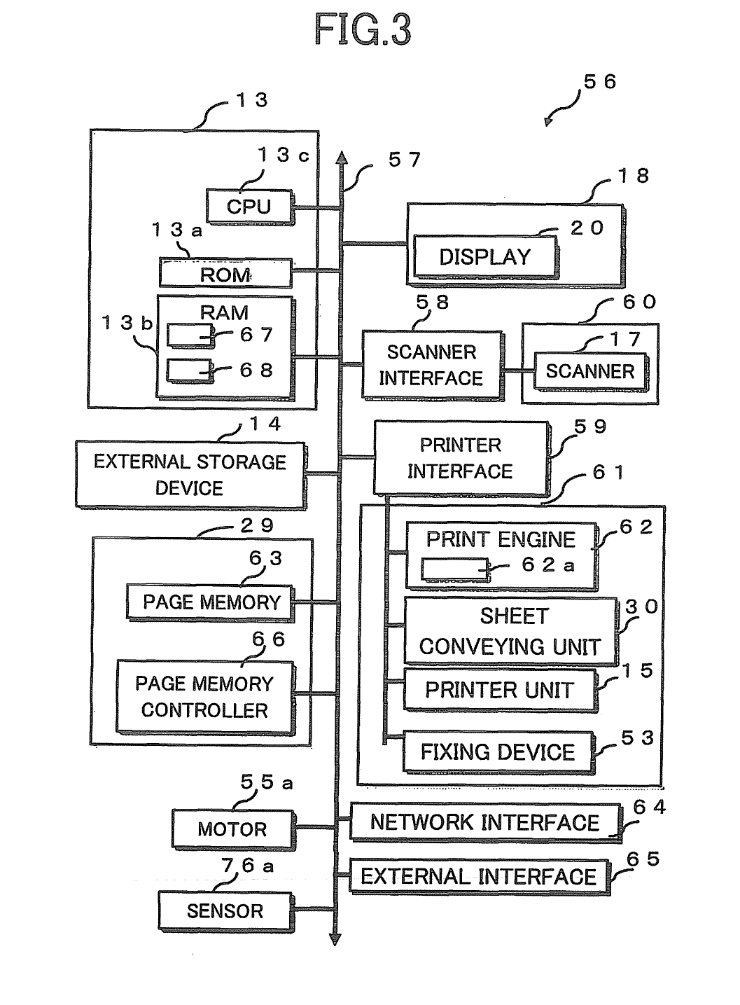

FIG. 3 is a block diagram of a control system of the MFP 1. The reference numerals and signs described above denote the same components.

A control system 56 includes data buses 57, the external storage device 14, a scanner interface 58, and a printer interface 59.

Data used for control flows to the data buses 57. The external storage device 14 stores image data and test pattern data.

The scanner interface 58 interfaces input and output of data between the main controller 13 and a scanner control system 60.

The scanner control system 60 includes the scanner 17, the automatic document feeder 12, the CCD sensor 28, a CPU, a ROM, and a RAM.

The printer interface 59 interfaces input and output of data between the main controller 13 and a print control system 61.

The print control system 61 includes a print engine 62, the sheet conveying unit 30, the printer unit 15, the fixing device 53, and a CPU, a ROM, and a RAM.

The print engine 62 includes the laser exposure unit 16 and a driver circuit 62a for the laser exposure unit 16. The driver circuit 62a modulates electric current flowing to the laser diodes 49 for the four colors and controls light emission of the laser diodes 49.

The control system 56 includes an image processing unit 29, a network interface 64, and an external interface 65.

The image processing unit 29 includes a page memory 63 and a page memory controller 66. A DRAM is used as the page memory 63. The page memory 63 stores image data for at least one page.

The network interface 64 interfaces input and output of data between the main controller 13 and a LAN (local area network).

An external apparatus including a USB (universal serial bus) interface is connected to the external interface 65. The external interface 65 inputs and outputs data between the main controller 13 and, for example, a USB memory.

The page memory controller 66 arbitrates plural accesses to the page memory 63. The accesses indicate accesses by the network interface 64, the external interface 65, the image processing unit 29, and the external storage device 14.

The page memory controller 66 controls an address for writing data in the page memory 63, an address for reading out data from the page memory 63, a readout direction, and the like. The page memory controller 66 receives an instruction from the CPU 13c.

The CPU 13c combines plural images in the page memory 63. The CPU 13c lays out an image to be print-output. The CPU 13c transitions an operation mode of the MFP 1 among plural modes.

The CPU 13c controls the scanner 17 and the printer unit 15 through the scanner interface 58 and the printer interface 59.

The ROM 13a stores a computer program that describes a procedure for adjusting an image position.

The CPU 13c uses the RAM 13b as a work area. The RAM 13b stores a numerical value and a command input by the user via the operation panel 18. The RAM 13b stores values necessary for execution of automatic printing explained later.

The RAM 13b includes a down-counter 67 for storing the number of times of repetition of the automatic printing.

The RAM 13b includes a step-width storing unit 68. The step-width storing unit 68 stores a step width. The step width indicates an amount of change of an adjustment value that occurs when the automatic printing is repeated.

The CPU 13c receives an operation instruction from the operation panel 18. The operation instruction indicates an input from the user in performing print setting and setting of various adjustment values for changing an image position.

The adjustment value is explained below with a margin amount as an example.

The user instructs the operation panel 18 to display a margin amount at the leading end of a sheet. The display 20 sets a value of the margin amount in a range of 0 to 255 with 128 set as a center value. The values 0 to 255 are display values to be displayed by the operation panel 18.

Among the values 0 to 255, for example, 10 or 20 is a display value indicating a step width. A display value 0 represents a minimum of a true value of the margin amount. A display value 255 represents a maximum of the true value of the margin amount.

A display value 128 is a center value among 256 display values. The CPU 13c calculates a difference between the maximum and the minimum of the margin amount. The CPU 13c divides the difference at equal intervals to obtain the 256 display values.

When the step width is 10, 118 or 138 is a shift value shifted from the center value 128. When the step width is 20, 108 or 148 is a shift value shifted from the center value 128.

The main controller 13 acquires the step width 10 from the operation panel 18. The main controller 13 calculates an added value obtained by adding a change amount to a current value of the margin amount and a subtracted value obtained by subtracting the change amount from the current value.

The main controller 13 print-outputs a numerical value character string together with a test pattern. The numerical value character string indicates a numerical value itself indicating the added value or the subtracted value and a character string indicating content of the numerical value.

An image position adjusting method according to this embodiment is a method used when the serviceperson adjusts an image position.

The main controller 13 automatically sets an adjustment value different from a currently-set adjustment value and causes the print control system 61 to print a value itself of the adjustment value set and the test pattern on a sheet.

The serviceperson installs the MFP 1 having the configuration explained above. The serviceperson begins to adjust the position of an image with respect to the sheet.

The serviceperson inputs a plural digit code to the keys 19 referring to the manual. The serviceperson causes the MFP 1 to execute processing procedures one by one.

A method of changing, with the operation panel 18, a leading end margin amount every time one sheet is printed is explained below.

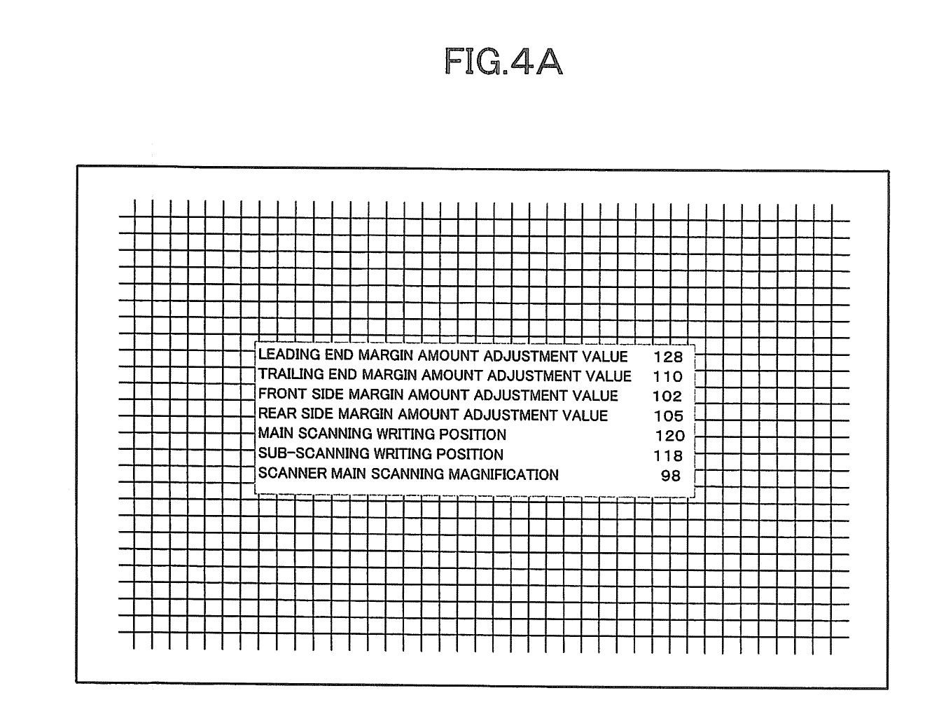

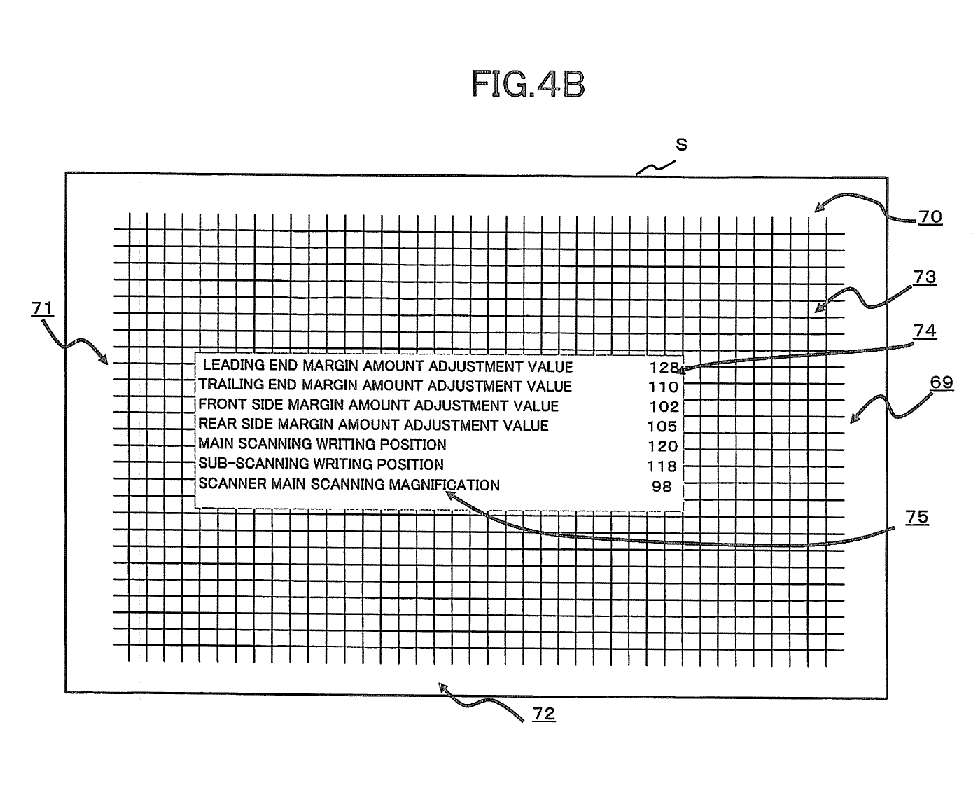

FIG. 4A is a diagram of a sheet itself on which a test pattern is printed. FIG. 4B is a diagram for explaining the test pattern on the sheet shown in FIG. 4A.

In FIGS. 4A and 4B, a direction from the left to right represents a sheet conveying direction. The positions of numerical value strings are an example.

A sheet S having a test pattern 73 thereon is printed. The printer unit 15 forms the test pattern on the sheet S in substantially the same manner as the formation of image data. The sheet S has a leading end 69, an end 70 at the rear side, a trailing end 71, and an end 72 at the front side.

As an example, a test pattern 73 is a lattice pattern. The test pattern 73 is a pattern for a person to check a magnification of an image and the position of a printed image. The check is visual check.

What is important is that the MFP 1 prints, in addition to the test pattern 73, plural numerical values respectively indicating adjustment values and character strings 75 respectively corresponding to the numerical values 74.

The numerical values 74 include not only adjustment values changed by printing or automatic printing explained later but also other adjustment values related to adjustment of an image position.

The main controller 13 changes, with respect to margin amounts, current values according to values input from the operation panel 18 and calculates added values and subtracted values. The main controller 13 adjusts the position of an image and print-outputs numerical value character strings together with the test pattern.

The main controller 13 repeats, plural times, processing including change of values of change amounts, calculation of values, adjustment of an image position, and print-output as one procedure.

The serviceperson compares print results of printed plural sheets. The serviceperson selects a sheet on which an image is placed in an expected position out of the plural sheets. The serviceperson sets adjustment values on the sheet in the MFP 1.

If there is no sheet on which an image is placed in the expected position, the serviceperson selects two sheets on which images are placed in positions close to the expected position.

The serviceperson calculates intermediate values of adjustment values on the two sheets. The serviceperson sets the values calculated in that way in the MFP 1.

The main controller 13 writes all adjustment values related to adjustment of an image position in a test pattern to be print-output. The serviceperson can easily check the adjustment values about to be printed.

An operation of the MFP 1 for automatically printing plural sheets is explained below.

First, the main controller 13 transitions a mode of the MFP 1 from a printing mode or a ready mode to an adjustment mode (an image position adjustment mode). The adjustment mode indicates a mode for a user to adjust an image position with respect to a sheet.

(1) The main controller 13 executes a procedure once.

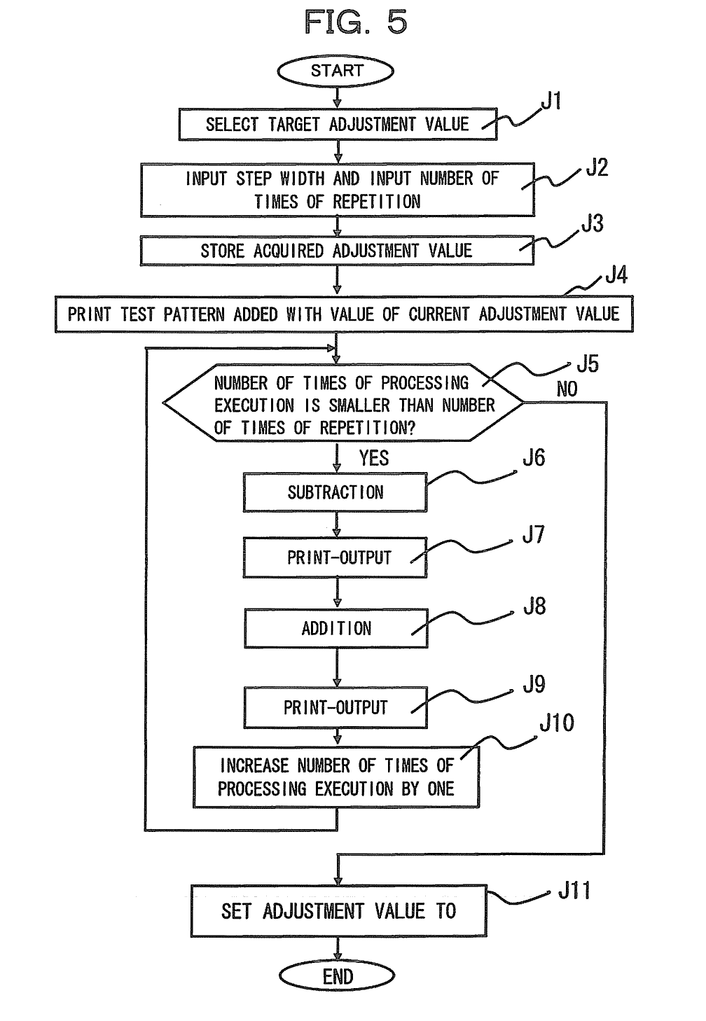

FIG. 5 is a flowchart for explaining an example of a processing procedure of automatic printing in adjusting one adjustment value.

In Act J1, the user selects a target adjustment value from the operation panel 18.

As an example, the user inputs a margin amount of a sheet leading end to the operation panel 18. The display 20 displays a display value in a range of 0 to 255 with 128 set as a center value. The display 20 urges the user to input a step width.

Control by the main controller 13 is control for increasing or reducing a margin amount of about 0.04 millimeter per one step of a display value. As the display value is smaller, the margin amount is smaller. As the display value is larger, the margin amount is larger.

A relation between a range of values that can be input, an initial value, a change amount per one step of a value, and the value and the margin amount is not limited to 0.04 millimeter or the like.

In Act J2, the operation panel 18 receives, for example, a step width 10. The operation panel 18 receives the number of times of repetition 1. The number of times of repetition is counted as 1 when two results of addition and subtraction are output.

The main controller 13 sets the number of times of processing execution “i” of an execution program to 0. The number of times of processing execution indicates a cumulative number of sheets. “i” represents a natural number smaller than a set number of times.

In Act J3, the main controller 13 stores the acquired adjustment value. The MFP 1 is enabled to print a test pattern in order to check a print result after adjustment.

The MFP 1 is enabled to, in addition to the printing of the test pattern, automatically change the adjustment value and print the adjustment value after the change on a sheet together with the test pattern.

The automatic printing for adjustment of an image position is hereinafter referred to as automatic printing. The main controller 13 executes the automatic printing.

Subsequently, in Act J4, the main controller 13 prints the current adjustment value together with the test pattern.

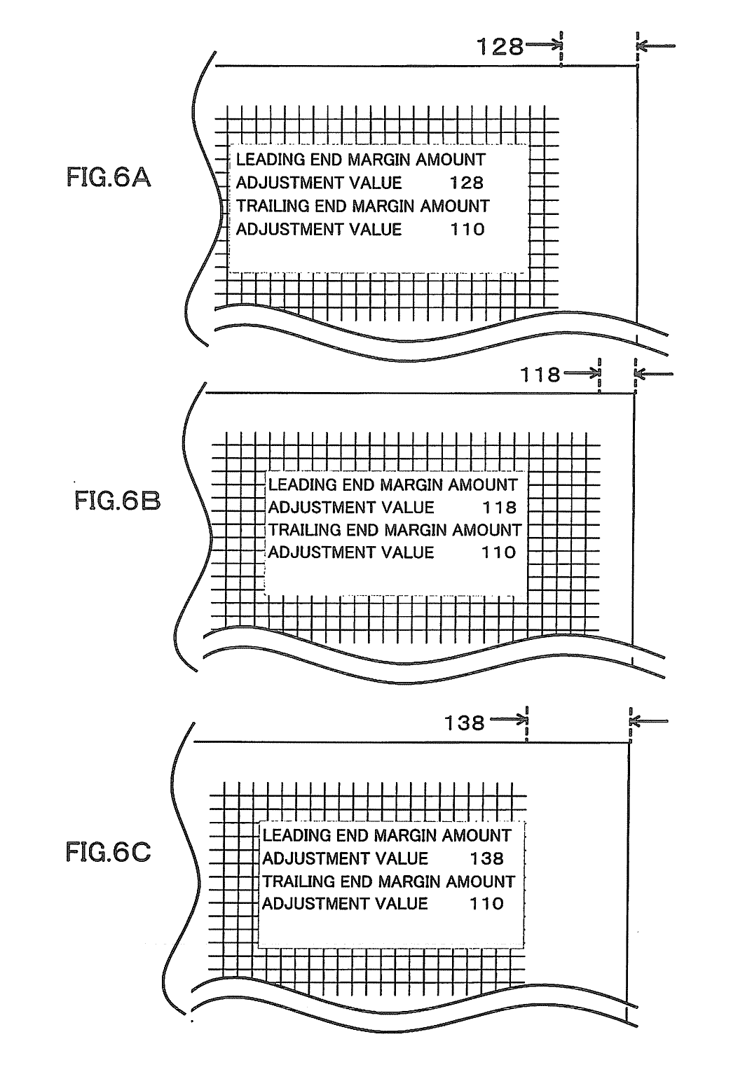

FIG. 6A is a diagram of print-output performed when a current value of a leading end margin amount is 128.

Subsequently, in Act J5, the main controller 13 determines whether the number of times of processing execution “i” reaches the number of times of repetition.

If the main controller 13 determines in Act J5 that the number of times of processing execution “i” does not reach the number of times of repetition (YES in Act J5), in Act J6, the main controller 13 subtracts a value corresponding to a step width set by the user from the current adjustment value.

In Act J7, the main controller 13 prints the current adjustment value together with the test pattern.

FIG. 6B is a diagram of print-output performed when the value of the leading end margin amount is 118.

In Act J8, the main controller 13 adds the value corresponding to the step width set by the user to the current adjustment value.

In Act J9, the main controller 13 prints the current adjustment value together with the test pattern.

FIG. 6C is a diagram of print-output performed when the value of the leading end margin amount is 138.

In Act J10, the main controller 13 increases the number of times of processing execution “i” by one.

The main controller 13 executes the processing in Act J5 again.

If the main controller 13 determines in Act J5 that the number of times of processing execution “i” reaches the number of times of repetition (NO in Act J5), in Act J11, the main controller 13 resets the adjustment value to the initial value.

As shown in FIGS. 6A to 6C, three sheets having the leading end margin amount of 128 and values respectively obtained by adding 10 to the leading end margin amount and subtracting 10 from the leading end margin amount are obtained.

The serviceperson visually compares print results of the three sheets. The serviceperson selects a sheet on which the leading end margin amount is a desired distance among the three sheets. The serviceperson inputs, for example, a numerical value 138 from the operation panel 18.

In this way, the main controller 13 sets 138 as the leading end margin amount. In the automatic printing in FIG. 5, the main controller 13 increases the step width by 10 every time the number of times of repetition increases by one. However, the main controller 13 may increase the step width to a double of the current step width, i.e., to 20 every time the number of times of repetition increases by one.

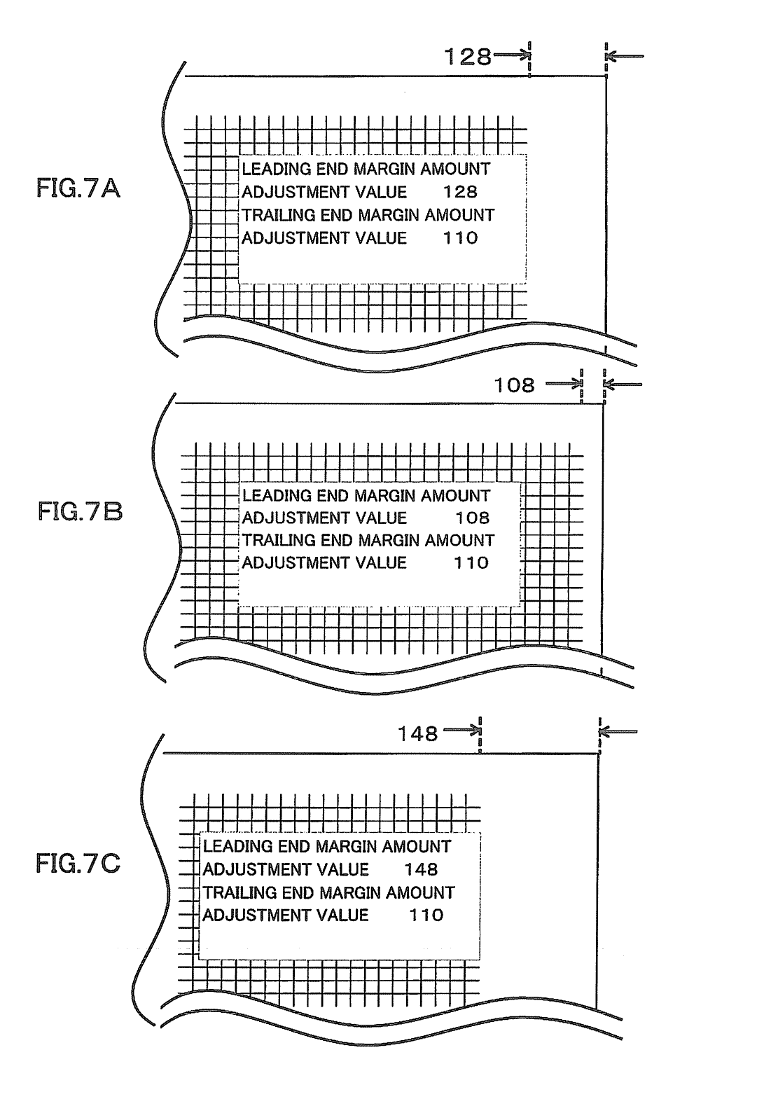

In FIGS. 7A to 7C, examples of print-output of an adjustment value of a margin amount at the double step width are shown. Three sheets having the leading end margin amount of 128 and values respectively obtained by adding 20 to the leading end margin amount and subtracting 20 from the leading end margin amount are obtained.

Concerning to which degree the step width is increased every time the number of times of repetition increases by one, the main controller 13 may select various multiples. The step width may be a triple or a number exceeding the triple. The step width may be a fractional multiple.

The main controller 13 may cause the MFP 1 to add a display value 1 or 2 to the step width at a time.

Irrespectively of which of the step widths is set, the main controller 13 resets the adjustment value by adding the step width to or subtracting the step width from the adjustment value.

The main controller 13 may adjust any one of a trailing end margin amount, a front side end margin amount, and a rear side end margin amount.

The main controller 13 may adjust anyone of a writing magnification, a reading magnification, and conveying speed.

(2) The main controller 13 executes the procedure twice.

In Act J2 in FIG. 5, the operation panel 18 may receive 2 as the user input.

As an example, the MFP 1 begins the automatic printing when the following three conditions are satisfied:

in Act J2, the operation panel 18 selects only an adjustment value of a margin amount of a sheet leading end as a target;

an adjustment value before the beginning of the automatic printing is 128; and

in Act J3, the main controller 13 sets 10 as the step width and sets a value 2 as the number of times of repetition.

First, the MFP 1 performs print-output with the adjustment value 128. Then, the MFP 1 performs print-output with an adjustment value 118. Subsequently, the MFP 1 performs print-output with an adjustment value 138.

The number of times of repetition is two. The MFP 1 doubles the step width 10 to set the step width to 20. The MFP 1 performs print-output again using 108 obtained by subtracting 20 from 128 and 148 obtained by adding 20 to 128. After the printing, the MFP 1 resets the adjustment value to the initial value 128 and ends the processing.

Five test patterns in total having adjustment values 108, 118, 128, 138, and 148 are printed.

The serviceperson compares fives sheets of a print result.

If a margin amount having the adjustment value 118 coincides with an expected margin amount, the serviceperson sets 118 as an adjustment value.

If the expected margin amount has a value around an intermediate value of the adjustment value 128 and the adjustment value 138, the serviceperson sets a value around 133.

(3) Plural adjustment values are automatically printed on plural sheets

In (1) and (2), the MFP 1 performs printing by changing only the margin amount of the sheet leading end. However, the user may input plural adjustment values to the MFP 1 in advance.

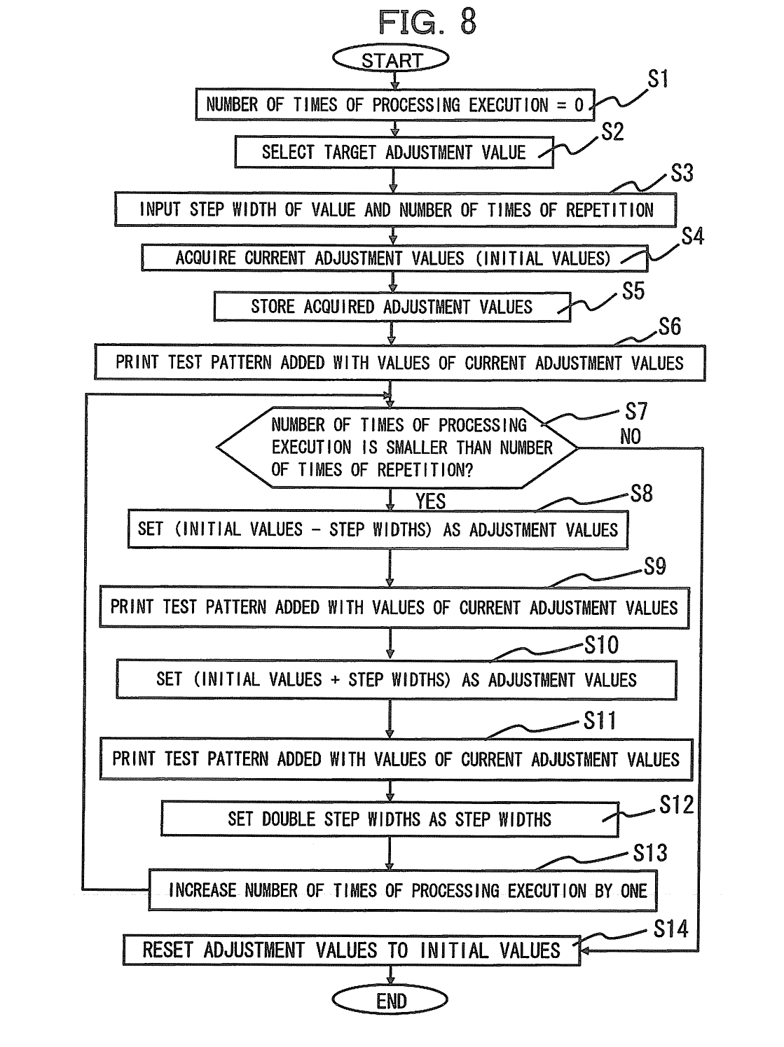

FIG. 8 is a flowchart for explaining an example of a processing procedure of automatic printing in adjusting two adjustment values. The main controller 13 executes the procedure.

Content of control by the main controller 13 is control for repeating a printing operation by a set number of times of repetition while simultaneously changing a leading end margin amount and a trailing end margin amount.

The main controller 13 starts the automatic printing.

The main controller 13 initializes the number of times of processing execution “i” to 0 (Act S1).

The main controller 13 instructs the operation panel 18 to urge the user to select an adjustment value as a target of the automatic printing (Act S2). The operation panel 18 displays a type of the adjustment value (Act S2). The operation panel 18 urges the user to input the adjustment value and waits for an input (Act S2).

The operation panel 18 receives the input of a leading end margin amount and a trailing end margin amount (Act S3). As an input example, a step width of the leading end margin amount is 10, the number of times of repetition is one, a step width of the leading end margin amount is 10, and the number of times of repetition is one.

A step width of a value and the number of times of repetition are input to the operation panel 18 as values. The main controller 13 acquires current adjustment values of the step width and the number of times of repetition (Act S4). For example, the main controller 13 obtains 128 as the leading end margin amount and 130 as the trailing end margin amount.

The main controller 13 stores the current adjustment values in the external storage device 14 as initial values, respectively (Act S5).

While keeping the current adjustment values, the main controller 13 prints a test pattern together with the currently-set adjustment values (Act S6).

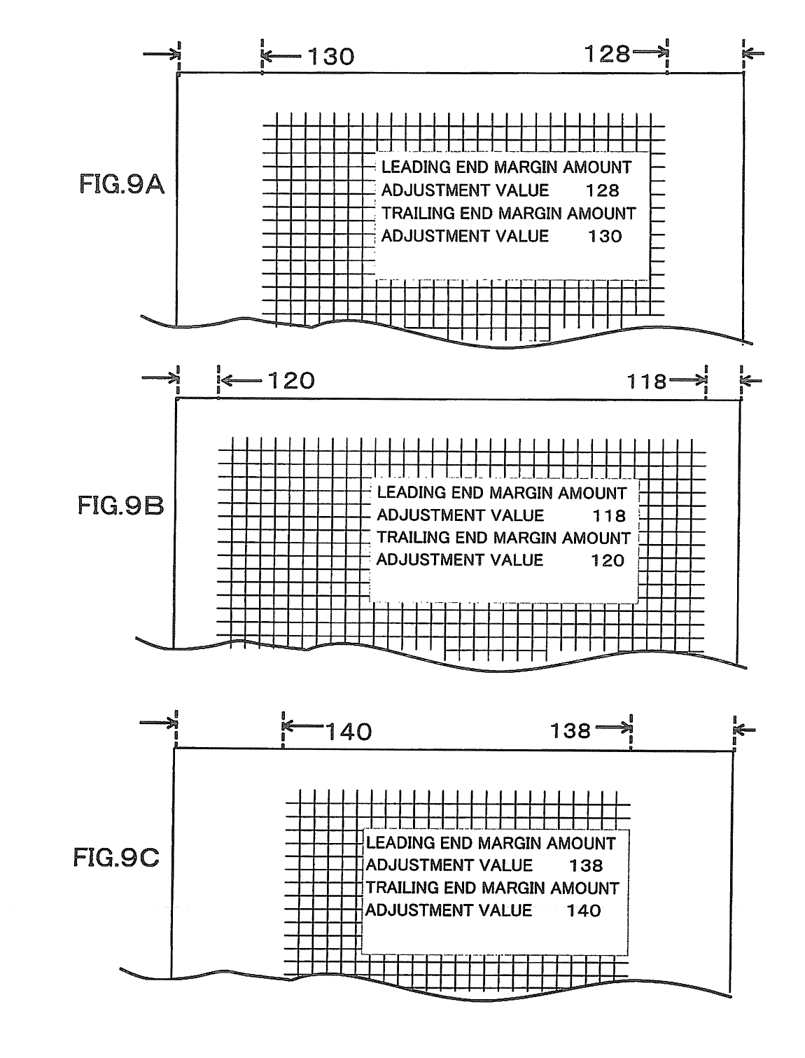

FIG. 9A is a diagram of print-output of the current leading end margin amount and the current trailing end margin amount.

Subsequently, the main controller 13 determines whether the number of times of processing execution “i” is smaller than the number of times of repetition (Act S7).

If it is determined in Act S7 that the number of times of processing execution “i” is smaller than the number of times of repetition (YES in Act S7), the main controller 13 subtracts the step widths from the current adjustment values (Act S8). The main controller 13 sets obtained two kinds of values as adjustment values anew (Act S8).

The main controller 13 prints the test pattern together with the adjustment values (Act S9).

FIG. 9B is a diagram of print-output of a subtracted value of the leading end margin amount and a subtracted value of the trailing end margin amount.

Thereafter, the main controller 13 acquires stored two kinds of initial values (Act S10). The main controller adds up the initial values and the steps widths, respectively (Act S10). The main controller 13 sets obtained two kinds of values as adjustment values anew (Act S10).

The main controller 13 prints the test pattern together with the adjustment values (Act S11).

FIG. 9C is a diagram of print-output of an added value of the leading end margin amount and an added value of the trailing end margin amount.

When the printing ends, the main controller 13 doubles the step widths (Act S12). Further, the main controller 13 adds 1 to the number of times of processing execution (Act S13).

The processing by the main controller 13 executes the processing in Act S7. The main controller 13 repeats the processing from Act S7 to Act S13.

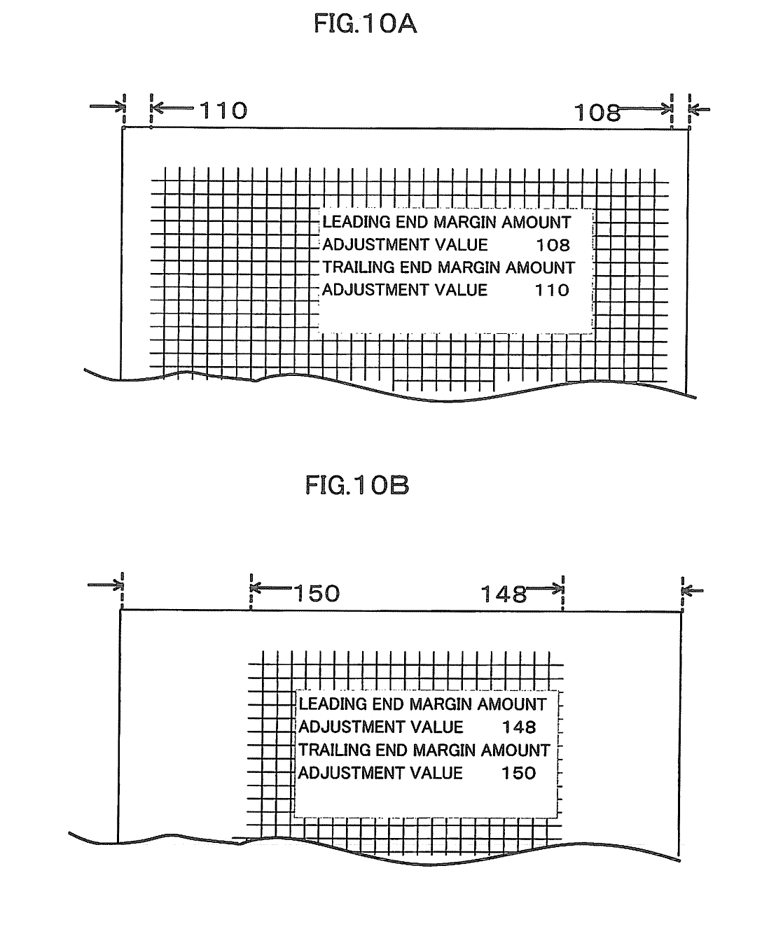

FIGS. 10A and 10B are diagrams of print-output of a sheet having double step widths with respect to the step width shown in FIG. 9A.

In Act S7, the main controller 13 determines again whether the number of times of processing execution “i” is larger than the number of times of repetition.

If the main controller 13 determines in Act S7 that the number of times of processing execution “i” is larger than the number of times of repetition (NO in Act S7), in Act S5, the main controller 13 acquires the initial values stored in Act S5 (Act S14).

The main controller 13 resets the adjustment values to the initial values at the start of the automatic printing (the initial values in Act S5) (Act S14). The main controller 13 ends the processing.

The main controller 13 can set values for the two adjustment values at a time. The MFP 1 can adjust image positions at a time.

The main controller 13 may adjust any two kinds among the leading end margin amount, the trailing end margin amount, the front side end margin amount, the rear side end margin amount, the writing magnification, the reading magnification, the conveying speed, and the like in combination as appropriate.

The main controller 13 may adjust kinds of parameters exceeding any two kinds among the leading end margin amount, the trailing end margin amount, the front side end margin amount, the rear side end margin amount, the writing magnification, the reading magnification, the conveying speed, and the like in combination as appropriate.

One sheet shows different adjustment values. A waste of sheets can be eliminated. Time required for adjustment of an image position can be reduced.

Since the MFP 1 can simultaneously change plural adjustment values, the MFP 1 is operable to further reduce time and labor for adjustment and, at the same time, prevent paper from being wastefully used.

If a plurality of the MFPs 1 are installed, appropriate values of plural adjustment values are different for each of the MFPs 1.

The MFP 1 enables to reduce time and labor for adjustment caused by an individual difference of the MFP 1 and reduce adjustment time.

(Modification)

In the embodiment, the main controller 13 may set adjustment values different from margin amounts. For example, the main controller 13 sets adjustment values (a) to (f) explained below.

(a) Reading Magnification

The main controller 13 may adjust a reading magnification by performing the automatic printing.

The serviceperson places an original document having a reference size on a glass plate 11. The operation panel 18 causes the scanner 17 to travel and read the original document.

The external storage device 14 stores a reference sheet width and a reference sheet length. The main controller 13 compares reference size information and size information output by the scanner 17 and corrects a reading magnification by the scanner 17.

The operation panel 18 sets a display value of the reading magnification in a range of 0 to 255. The main controller 13 acquires a step width input by the user. The main controller 13 changes the reading magnification from a current reading magnification to an input reading magnification.

The main controller 13 print-outputs an adjustment value of the reading magnification together with a test pattern. The main controller 13 adds the step width to or subtracts the step width from the reading magnification, and sets the reading magnification obtained by performing the addition or the subtraction.

(b) Writing Magnification

The main controller 13 may adjust a writing magnification by performing the automatic printing.

The main controller 13 adjusts write start timing of a laser beam for each of mirror surfaces of the polygon mirror 46 and corrects a beam write start position in a sub-scanning direction. The main controller 13 corrects, with a synchronization signal, a beam write start position in a main scanning direction.

The writing magnification is an adjustment value determined by the rotating speed of the polygon mirror 46 and the rotating speed of the photoconductive drums 36.

The operation panel 18 displays one display value in a range of 0 to 255 for changing the rotating speeds. The main controller 13 acquires a step width input by the user. The main controller 13 changes the writing magnification from a current writing magnification to an input writing magnification.

The main controller 13 print-outputs an adjustment value of the writing magnification together with a test pattern. The main controller 13 adds the step width to and subtracts the step width from the writing magnification, and sets the writing magnification obtained by performing the addition and the subtraction.

The laser exposure unit 16 expands or reduces a document image according to the writing magnification.

(c) Conveying Speed

The main controller 13 may adjust conveying speed for conveyance of a sheet by the sheet conveying unit 30 by performing the automatic printing.

The external storage device 14 stores values of rotating speeds of the motor 55a, the motor 55b, and the motor for the primary transfer roller 39. The main controller 13 controls driving of the motor 55a, the motor 55b, and the like according to the rotating speed values.

The operation panel 18 sets a display value of the conveying speed in a range of 0 to 255. The main controller 13 acquires a step width input by the user.

The main controller 13 changes the conveying speed from current conveying speed to input conveying speed. The main controller 13 adjusts the size of an image according to the conveying speed after the change.

The main controller 13 shifts speed of paper feeding and speed of transfer and changes print process speed. The main controller 13 adjusts the position of an image.

(d) Temperature of the Photoconductive Drums 36

The main controller 13 may adjust the temperature of the drum surfaces of the photoconductive drums 36 by performing the automatic printing.

The printer unit 15 includes environment sensors 76 away from the surfaces of the photoconductive drums 36. The environment sensors 76 detect environment temperature and environment humidity of the drum surfaces.

The operation panel 18 sets a display value of the temperature in a range of 0 to 255. The main controller 13 acquires a step width input by the user. The main controller 13 changes the temperature from current temperature to input temperature.

The main controller 13 print-outputs an adjustment value of the temperature together with a test pattern. The main controller 13 adds the step width to or subtracts the step width from the temperature and sets the temperature obtained by performing the addition or the subtraction.

The main controller 13 corrects, according to outputs of the environment sensors 76, a change amount having magnitude corresponding to magnitude of expansion or shrinkage of the photoconductive drums 36.

For example, the main controller 13 changes a bias value of the chargers. The main controller 13 changes heat time and heat temperature of drum heaters.

The main controller 13 adjusts, using the environment humidity detected by the environment sensors 76, a value in substantially the same manner as the example of the setting of the environment temperature.

(e) Temperature of the Belt 35

The main controller 13 may adjust the temperature of the belt surface of the belts 35 by performing the automatic printing.

The printer unit 15 includes an environment sensor away from the belt surface of the belt 35. The environment sensor 77 detects environment temperature and environment humidity of the belt surface.

The main controller 13 print-outputs an adjustment value of the temperature together with a test pattern in substantially the same manner as the example of the photoconductive drums 36.

The main controller 13 corrects, according to an output of the environment sensor 77, a change amount having magnitude corresponding to magnitude of expansion and shrinkage of the belt 35. For example, the main controller 13 changes a bias value of the primary transfer roller 39.

(f) Sheet Length of an Output of the Fixing Device 53

The main controller 13 may adjust, by performing the automatic printing, an image position according to a change in sheet length of a sheet output by the fixing device 53.

Moisture of a sheet is evaporated by heat. In some case, the fixing device 53 outputs a sheet expanded or shrunken by temperature or humidity.

The fixing device 53 includes an environment sensor 78. The environment sensor 78 detects environment temperature and environment humidity around the heat roller 53a.

The operation panel 18 sets a display value of the temperature in a range of 0 to 255. The main controller 13 acquires a step width input by the user. The main controller 13 changes the temperature from current temperature to input temperature.

The main controller 13 print-outputs an adjustment value of the temperature together with a test pattern. The main controller 13 adds the step width to or subtracts the step width from the temperature and sets the temperature obtained by performing the addition or the subtraction.

The main controller 13 corrects, according to an output of the environment sensor 78, a change amount having magnitude corresponding to magnitude of expansion or shrinkage of a sheet on which fixing is executed by the fixing device 53.

The main controller 13 adjusts a value in substantially the same manner as the example of the setting of the environment temperature using the environment humidity detected by the environment sensor 78.

Plural adjustment values as targets of change of values can be simultaneously adjusted. Time and labor for adjustment is reduced.

### OTHER EMBODIMENTS

In the embodiment explained above, the image forming apparatus may be a monochrome printer or copy machine.

The main controller 13 may variously change the positions of numerical value character strings.

The main controller 13 may variously change a test pattern. For example, a chart painted in black or gray over an entire sheet surface may be used as the test pattern.

What is claimed is:

1. An image forming apparatus comprising:
an image processing unit configured to generate image data and test pattern data;
a printer configured to print an image or a test pattern on a sheet surface of a sheet according to print data output by the image processing unit;
a memory configured to store an adjustment value for changing a position where the printer forms an image on the sheet surface;
an operation panel configured to receive a change for the adjustment value according to a user input;
an adjuster configured to change, according to input information from the operation panel, the adjustment value stored by the memory from a first value to a second value; and
a print controller configured to adjust the position according to the second value set by the adjuster and cause the printer to print a numerical value character string representing the second value together with the test pattern.

2. The apparatus of claim 1, wherein
the adjuster changes each of plural kinds of the adjustment value, and
the print controller adjusts the position according to second values and causes the printer to print the second values on the sheet surface at a time.

3. The apparatus of claim 1, wherein the adjuster acquires, from the operation panel, a center value among plural values obtained by dividing a difference between a maximum and a minimum of the adjustment value at equal intervals and a step width indicating a change amount between shift values shifted from the center value and calculates an added value obtained by adding the change amount to a current value of the adjustment value and a subtracted value obtained by subtracting the change amount from the current value.

4. The apparatus of claim 3, wherein
the adjuster acquires a number of times of repetition designated by a user from the operation panel, and
the print controller executes, over the number of times of repetition, as one procedure, processing for changing a value of the change amount, calculating the added value and the subtracted value, adjusting a position of the image, and causing the printer to print the numerical value character string together with the test pattern.

5. The apparatus of claim 3, wherein the adjuster acquires, from the operation panel, a plurality of the step widths respectively indicating a plurality of the change amounts different from one another and calculates added values and subtracted values.

6. The apparatus of claim 5, wherein
the adjuster acquires a number of times of repetition designated by the user from the operation panel, and
the print controller executes, over the number of times of repetition, as one procedure, processing for changing values of the change amounts, calculating the added values and the subtracted values, adjusting a position of the image, and causing the printer to print the numerical value character string together with the test pattern.

7. The apparatus of claim 1, wherein
the memory stores, as the adjustment value, a value of a margin amount between any one of sheet ends and an area where the image is printed,
the adjuster changes the margin amount from a first margin amount to a second margin amount, and
the print controller adjusts width of a margin according to the second margin amount.

8. The apparatus of claim 1, wherein
the memory stores, as the adjustment value, a value of conveying speed of a sheet conveying unit configured to convey the sheet,
the adjuster changes the conveying speed from first conveying speed to second conveying speed, and
the print controller adjusts size of the image according to the second conveying speed.

9. The apparatus of claim 1, wherein
the memory stores, as the adjustment value, a value of a reading magnification at which a scanner reads a document image from an original document,
the adjuster changes the reading magnification from a first reading magnification to a second reading magnification, and
the print controller adjusts size of the image according to the second reading magnification.

10. The apparatus of claim 1, wherein
the memory stores, as the adjustment value, a value of a writing magnification at which a laser exposure unit in the printer writes the image data in the sheet,
the adjuster changes the writing magnification from a first writing magnification to a second writing magnification, and
the print controller adjusts size of the image according to the second writing magnification.

11. The apparatus of claim 1, wherein
the printer includes:
an image forming unit configured to develop an electrostatic latent image formed on a photoconductive drum and form a developer image; and
an environment sensor for the photoconductive drum, wherein
the print controller print-outputs, according to an output of the environment sensor, the numerical value character string having magnitude corresponding to magnitude of expansion or shrinkage of the photoconductive drum.

12. The apparatus of claim 1, wherein
the printer includes:
an image forming unit configured to develop an electrostatic latent image formed on a photoconductive drum and form a developer image;
a transfer belt configured to transfer the developer image on the photoconductive drum onto the sheets; and
an environment sensor for the transfer belt, wherein
the print controller print-outputs, according to an output of the environment sensor, the numerical value character string having magnitude corresponding to magnitude of expansion or shrinkage of the transfer belt.

13. The apparatus of claim 1, further comprising:
a fixing device configured to fix the image or the test pattern on the sheet output by the printer; and
an environment sensor in the fixing device, wherein
the print controller print-outputs, according to an output of the environment sensor, the numerical value character string having magnitude corresponding to magnitude of shrinkage of the sheet received from the fixing device.

14. An image position adjusting method comprising:
setting, in a memory, a first value of an adjustment value for changing a position where an image is formed on a sheet surface of a sheet;
printing a first numerical value character string representing the first value on a first sheet together with the test pattern;
changing the adjustment value from the first value to a second value different from the first value according to input information received from an operation panel; and
printing a second numerical value character string representing the second value on a second sheet together with the test pattern.

15. The method of claim 14, further comprising:
inputting, from the operation panel, a center value among plural values obtained by dividing a difference between a maximum and a minimum of the adjustment value at equal intervals and a step width indicating a change amount between shift values shifted from the center value;
calculating an added value obtained by adding the change amount to the first value and a subtracted value obtained by subtracting the change amount from the first value; and
printing the second numerical value character string representing the added value or the subtracted value.

16. The method of claim 15, further comprising:
acquiring a number of times of repetition designated by a user from the operation panel; and
repeating, over the number of times of repetition, as one procedure, processing for changing a value of the change amount, calculating the added value and the subtracted value, adjusting a position of the image, and print-outputting the second numerical value character string together with the test pattern.

17. The method of claim 15, further comprising:
acquiring, from the operation panel, a plurality of the step widths respectively indicating a plurality of the change amounts different from one another;
calculating added values and subtracted values; and
printing a plurality of the second numerical value character strings representing the added values or the subtracted values.

18. The method of claim 17, further comprising:
acquiring a number of times of repetition designated by the user from the operation panel; and
repeating, over the number of times of repetition, as one procedure, processing for changing values of the change amounts, calculating the added values and the subtracted values, adjusting a position of the image, and print-outputting the second numerical value character strings together with the test pattern.

19. The method of claim 16, further comprising:
setting an intermediate value of adjustment values indicated by the second numerical value character strings on a pair of the sheets among a plurality of the sheets obtained by repeating the processing over the number of times of repetition; and
printing a third numerical value character string representing the value after the change.

20. The method of claim 18, further comprising:
setting an intermediate value of adjustment values indicated by the second numerical value character strings on a pair of the sheets among a plurality of the sheets obtained by repeating the processing over the number of times of repetition; and
printing a fourth numerical value character string representing the value after the change.
